(19) United States
(12) Patent Application Publication
(10) Pub. No.: US 2024/0243313 A1
(43) Pub. Date: Jul. 18, 2024

(54) FUEL CELL SYSTEM AND FUEL CELL SYSTEM CONTROL METHOD

(71) Applicants: HYUNDAI MOTOR COMPANY, Seoul (KR); KIA CORPORATION, Seoul (KR)

(72) Inventor: Hyun Seung Lee, Seoul (KR)

(73) Assignees: HYUNDAI MOTOR COMPANY, Seoul (KR); KIA CORPORATION, Seoul (KR)

(21) Appl. No.: 18/521,260

(22) Filed: Nov. 28, 2023

(30) Foreign Application Priority Data
Jan. 13, 2023 (KR) 10-2023-0005463

(51) Int. Cl. H01M 8/04664; H01M 8/04089; H01M 8/04746; H01M 8/04858

(52) U.S. Cl. CPC H01M 8/04679; H01M 8/04097; H01M 8/04753; H01M 8/0494

(57) ABSTRACT

A fuel cell system and a fuel cell system control method are proposed. The fuel cell system includes a controller configured to control the opening ratio of an air recirculation valve or the speed of a hydrogen recirculation pump according to the required output of the fuel cell stack and a magnitude of an output voltage or output current.

### CROSS REFERENCE TO RELATED APPLICATION

The present application claims priority to Korean Patent Application No. 10-2023-0005463, filed Jan. 13, 2023, the entire contents of which h are incorporated herein for all purposes by this reference.

### TECHNICAL FIELD

The present disclosure relates generally to a fuel cell system and a fuel cell system control method. More particularly, the present disclosure relates to a technique capable of minimizing deterioration of a fuel cell stack and efficiently satisfying the required output of the fuel cell stack by employing an air recirculation valve and a hydrogen recirculation pump.

### BACKGROUND

A fuel cell is a device that generates electrical energy through an electrochemical reaction inside a fuel cell stack by receiving hydrogen and air supplied from external sources. The fuel cell can be used as a power source for various applications, such as fuel cell electric vehicles (FCEVs) and fuel cells for power generation.

Fuel cell systems generally include a fuel cell stack that is used as a power source, in which a plurality of fuel cells is stacked. The fuel cell systems also include a fuel supplying system for supplying a fuel, i.e., hydrogen, to the fuel cell stack. The fuel cell systems also include an air supplying system for supplying an oxidizing agent required for an electrochemical reaction, i.e., oxygen. The fuel cell systems also include a thermal management system for controlling the temperature of the fuel cell stack.

The fuel supplying system depressurizes compressed hydrogen stored in a hydrogen tank and supplies the depressurized hydrogen to an anode (fuel electrode) of the fuel cell stack. The air supplying system supplies inhaled external air to a cathode (air electrode) of the fuel cell stack by operating an air compressor.

When hydrogen is supplied to the anode of the fuel cell stack and oxygen is supplied to the cathode thereof, hydrogen ions are separated from the anode through a catalytic reaction. The separated hydrogen ions are transferred to the cathode through an electrolyte membrane. At the cathode, the hydrogen ions separated from the anode react electrochemically with electrons and oxygen to produce electrical energy. In more detail, hydrogen is electrochemically oxidized at the anode and oxygen is electrochemically reduced at the cathode. At this time, the movement of produced electrons generates electricity and heat. Water vapor or water is generated through a chemical reaction where hydrogen and oxygen are combined.

Meanwhile, an exhausting device is provided for discharging by-products, such as water vapor, water, and heat, which result from the generation of electricity through the fuel cell stack, and non-reacted hydrogen and oxygen. Gases, such as water vapor, hydrogen, and oxygen, are exhausted to the atmosphere through an exhaust passage.

The electrochemical reaction occurring inside the fuel cell is represented by the reaction equation as follows.

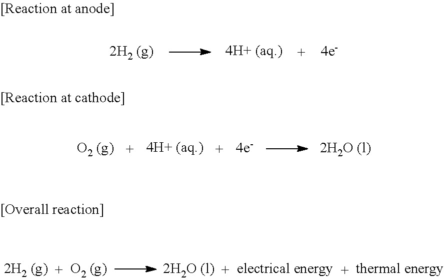

As illustrated in the above reaction equation, hydrogen molecules are decomposed at the anode to generate four hydrogen ions and four electrons. As the electrons move through an external circuit, the flow of electrons produces current (electrical energy). The hydrogen ions move to the cathode through the electrolyte membrane and undergo a cathodic reaction, and thus water and heat are produced as by-products. Meanwhile, in a fuel cell system, a plurality of fuel cell stacks is arranged side by side (e.g., a power generation facility using fuel cells or a truck with large fuel cells). When a fuel cell system is operated, insufficient pressures of hydrogen gas and air gas in the fuel cell stack may cause voltage and current deviations between cells of the fuel cell stack and thus lead to deterioration of the fuel cell stack.

In other words, during high-output operation of the fuel cell stack, large amounts of high-pressure hydrogen and air are introduced, so the pressure deviation between cells is not large. On the contrary, during low-output operation of the fuel cell stack, a small amount of hydrogen gas or air introduced is sufficient to satisfy a required power output of the stack. However, since distribution of hydrogen or air between cells is uneven due to insufficient pressure of the introduced hydrogen or air, the voltage and current deviations between cells may be large. Consequently, this may increase deterioration of the fuel cell stack.

The foregoing description is intended merely to aid in understanding the background of the present disclosure. The foregoing description is not intended to mean that the present disclosure falls within the purview of the related art that is already known to those having ordinary skill in the art.

### SUMMARY

Accordingly, the present disclosure has been made keeping in mind the above problems occurring in the related art. Objectives of the present disclosure are to provide a fuel cell system and a fuel cell system control method that can minimize deterioration of a fuel cell stack while efficiently coping with an increase or reduction in the required output of the fuel cell stack. The fuel cell system and the fuel cell system control method can simultaneously satisfy a target current and a target voltage within an appropriate range suitable for the required output of the fuel cell stack.

In order to achieve the above objectives, according to one aspect of the present disclosure, fuel cell system is provided. The fuel cell system includes an air line configured to supply air, pressurized by an air compressor, to a cathode of a fuel cell stack. The fuel cell system also includes a hydrogen line configured to supply hydrogen to an anode of the fuel cell stack. The fuel cell system also includes an air recirculation line branched from the air line and configured to connect an outlet side and an inlet side of the cathode. The fuel cell system also includes an air control valve provided on the air line and configured to control a flow rate of air supplied to the cathode. The fuel cell system also includes an air recirculation valve provided at an outlet side of the air line and configured to control a flow rate of air flowing into the air recirculation line. The fuel cell system also includes a hydrogen recirculation line branched from the hydrogen line and configured to connect an outlet side and an inlet side of the anode. The fuel cell system also includes a hydrogen recirculation pump provided on the hydrogen recirculation line and configured to pressurize recirculated hydrogen. The fuel cell system also includes a controller configured to adjust a flow rate of recirculated air or hydrogen according to a required output of the fuel cell stack and a magnitude of an output voltage or output current.

The controller may adjust the flow rate of recirculated air or hydrogen by adjusting a speed of the air compressor, by adjusting an opening ratio of the air control valve, by adjusting an opening ratio the air recirculation valve, or by adjusting a speed of the hydrogen recirculation pump.

The controller may increase the flow rate of recirculated air by increasing the opening ratio of the air recirculation valve or decreases the flow rate of recirculated air by reducing the opening ratio of the air recirculation valve. The controller may adjust a pressure of recirculated air by adjusting the speed of the air compressor or the opening ratio of the air control valve.

When the required output of the fuel cell stack does not exit, the controller may maintain supply of hydrogen through the hydrogen line or the hydrogen recirculation line and supply recirculated air to the cathode through the air recirculation line.

The controller may store an upper limit value and a lower limit value of the output voltage of the fuel cell stack. When the required output of the fuel cell stack exists, the controller may control power generation of the fuel cell stack so that the output voltage of the fuel cell stack is maintained between the upper limit value and the lower limit value.

When the output voltage of the fuel cell stack exceeds the upper limit value, the controller may reduce the output voltage to be equal to or less than the upper limit value 1) by increasing a supply amount of the hydrogen line or the air line when it is possible to increase the output current, and 2) by increasing the speed of the hydrogen recirculation pump or increasing the opening ratio of the air recirculation valve when increasing the output current is limited.

When the output voltage of the fuel cell stack is less than the lower limit value, the controller may increase the output voltage to be equal to or higher than the lower limit value depending on whether the fuel cell stack is generating power and whether the output current is variable.

When it is determined that the fuel cell stack is not generating power, the controller may increase a supply amount of the hydrogen line or the air line so that the output voltage is increased to be equal to or higher than the lower limit value.

When it is possible to immediately generate the output current of the fuel cell stack, the controller may control a voltage by increasing the supply amount of the hydrogen line or the air line. When it is not possible to immediately generate the output current, the controller may increase the supply amount of the hydrogen line, may increase an opening ratio of the air recirculation valve, and then may increase the supply amount of the air line so that the output voltage is increased to be equal to higher than the lower limit value.

When it is determined that the fuel cell stack is generating power and it is possible to reduce the output current of the fuel cell stack, the controller may increase a speed of the hydrogen recirculation pump or increase an opening ratio of the air recirculation valve and may reduce a supply amount of the hydrogen line or the air line so that the output voltage is increased to be equal to or higher than the lower limit value. When it is not possible to reduce the output current, the controller may increase the supply amount of the hydrogen line or the air line so that the output voltage is increased to be equal to or higher than the lower limit value.

When the required output of the fuel cell stack exists, the controller may check a current voltage of the fuel cell stack. When the current voltage is within a normal range, the controller may control power generation of the fuel cell stack by varying the output current or output voltage of the fuel cell stack depending on whether the required output of the fuel cell stack is increased or reduced.

When the required output of the fuel cell stack is increased, the controller may control a current or voltage by increasing a supply amount of the hydrogen line or the air line and reducing a speed of the hydrogen recirculation pump or reducing an opening ratio of the air recirculation valve.

When the required output of the fuel cell stack is reduced, the controller may control power generation of the fuel cell stack by varying the output current or output voltage by reducing a supply amount of the hydrogen line or the air line and by increasing a speed of the hydrogen recirculation pump or increasing an opening ratio of the air recirculation valve.

According to another aspect of the present disclosure, a method of controlling the fuel cell system includes determining, by the controller, the magnitude of the output voltage or output current according to the required output of the fuel cell stack. The method also includes controlling, by the controller, the flow rate of recirculated air or hydrogen according to the determined magnitude of the output voltage or output current.

The controller may adjust the flow rate of recirculated air or hydrogen by adjusting a speed of the air compressor, by adjusting an opening ratio of the air control valve, by adjusting an opening ratio of the air recirculation valve, or by adjusting a speed of the hydrogen recirculation pump.

According to the fuel cell system and the fuel cell system control method according to the present disclosure, the fuel cell stack can be controlled to satisfy the required output of the fuel cell stack by converting the output voltage and output current of the fuel cell stack into independent variables. Thus, the fuel cell system and the fuel cell system control method may minimize deterioration of the fuel cell stack while efficiently coping with an increase or reduction in the required output of the fuel cell stack. The fuel cell system and the fuel cell system control method may simultaneously satisfy the target current and target voltage within the appropriate range suitable for the required output of the fuel cell stack.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a view illustrating a fuel cell system according to an embodiment of the present disclosure;

FIG. 2 is a flowchart illustrating voltage control according to an embodiment of the present disclosure;

FIGS. 3, 4, and 5 are graphs illustrating the voltage control according to the embodiment of the present disclosure;

FIG. 6 is a flowchart illustrating current control according to an embodiment of the present disclosure; and

FIGS. 7 and 8 are graphs illustrating the current control according to the embodiment of the present disclosure.

### DETAILED DESCRIPTION

Hereinafter, embodiments disclosed in the present disclosure are described in detail with reference to the accompanying drawings. In the present disclosure, identical or similar constituent elements are given the same reference numerals regardless of the reference numerals of the drawings, and a repeated description thereof has been omitted.

In the description of the present disclosure, where it has been determined that the detailed description of the related art would obscure the gist of the present disclosure, the detailed description thereof has been omitted. In addition, the accompanying drawings are merely intended to be able to readily understand the embodiments disclosed herein, and thus the technical idea disclosed herein is not limited by the accompanying drawings. It should be understood to include all changes, equivalents, and substitutions included in the idea and technical scope of the present disclosure.

It should be understood that, although terms, such as “first”, “second”, etc., may be used herein to describe various elements, these elements should not be limited by these terms. These terms are only used to distinguish one element from another element.

As used herein, the singular forms “a”, “an”, and “the” are intended to include the plural forms as well, unless the context clearly indicates otherwise.

It should be further understood that terms, such as “comprise”, “include”, “have”, etc., and variations thereof, when used herein, specify the presence of stated features, integers, steps, operations, elements, components, and/or combinations thereof. These terms do not preclude the presence or addition of one or more other features, integers, steps, operations, elements, components, and/or combinations thereof. When a component, device, element, or the like of the present disclosure is described as having a purpose or performing an operation, function, or the like, the component, device, element, or the like should be considered herein as being “configured to” meet that purpose or to perform that operation or function. Each component, device, element, and the like may separately embody or be included with a processor and a memory, such as a non-transitory computer readable media, as part of the apparatus.

A fuel cell system according to the present disclosure includes an air line 100 supplying air pressurized by an air compressor 150 to a cathode of a fuel cell stack. The fuel cell system also includes a hydrogen line 200 supplying hydrogen to an anode of the fuel cell stack. The fuel cell system also includes an air recirculation line 180 branched from the air line 100 and connecting an outlet side and an inlet side of the cathode. The fuel cell system also includes an air control valve 130 provided on the air line 100 and controlling the flow rate of air supplied to the cathode. The fuel cell system also includes an air recirculation valve 170 provided at an outlet side of the air line 100 and controlling the flow rate of air introduced into the air recirculation line 180. The fuel cell system also includes a hydrogen recirculation line 280 branched from the hydrogen line 200 and connecting an outlet side and an inlet side of the anode. The fuel cell system also includes a hydrogen recirculation pump 290 provided on the hydrogen recirculation line 280 and pressurizing recirculated hydrogen. The fuel cell system also includes a controller 500 adjusting the flow rate of recirculated air or hydrogen according to the required output of the fuel cell stack 600 and the magnitude of an output voltage or output current.

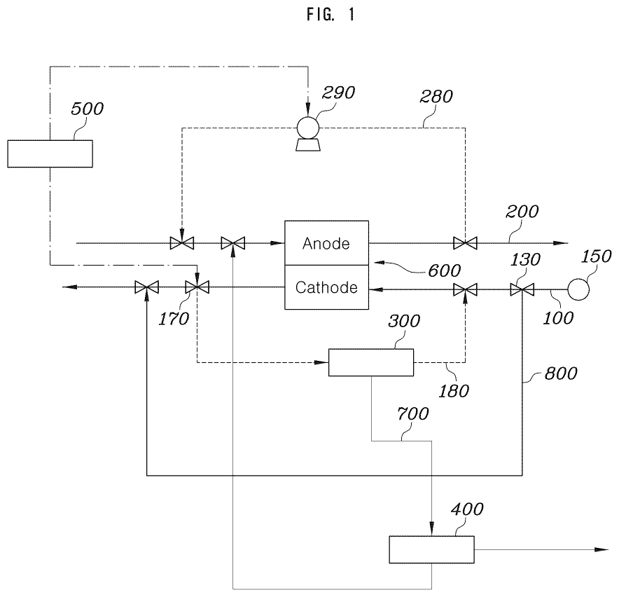

FIG. 1 is a view illustrating a fuel cell system according to an embodiment of the present disclosure. The fuel cell system according to the present disclosure is described with reference to FIG. 1.

A gas-liquid separator 300 provided on the air recirculation line 180 separates air and water existing in the air recirculation line 180 and transfers the separated water to a humidifier 400 through a humidification line 700.

The separated water is stored in the humidifier 400. A part of the stored water is supplied to the anode of the fuel cell stack 600 to maintain the anode at a predetermined humidity or higher. When the water stored in the humidifier 400 reaches a predetermined water level or higher, the humidifier 400 discharges the water to the outside of the fuel cell system.

The air bypass line 800 is a line for bypassing air introduced from the outside and discharging the air to the outside when the air control valve 130 closes the air line 100 and prevents the air from being introduced into the cathode in a situation, such as where ignition of the fuel cell stack 600 is turned off.

The air line 100 is a line for transferring pressurized air to the cathode through the air compressor 150 provided at a front end of the air line 100.

The hydrogen line 200 is a line for transferring high-pressure hydrogen gas to the anode.

The air recirculation line 180 is a line that is branched from the air line 100 and connecting the outlet side and the inlet side of the cathode and guides already used air to be introduced into the cathode again.

The air passing through the cathode is introduced into the air recirculation line 180 through the air recirculation valve 170. At this time, the amount of discharged air and the amount of recirculated air may be determined according to the opening ratio of the air recirculation valve 170.

The air recirculated at the outlet side of the air recirculation line 180 is pressurized by pressurized air newly introduced through the air control valve 130 and then introduced into the cathode again.

At this time, the flow rate and pressure of air newly introduced into the cathode may be determined by adjusting the speed of the air compressor 150 and the opening ratio of the air control valve 130, and air excluding the determined flow rate may be discharged to the outside through the air bypass line 800.

The hydrogen recirculation line 280 is a line that is branched from the hydrogen line 200, connects the outlet side and the inlet side of the anode, and guides already used hydrogen gas to be introduced into the anode again. In other words, the already used hydrogen is pressurized by the hydrogen recirculation pump 290 provided on the hydrogen recirculation line 280 and is then introduced into the anode again.

The controller 500 controls the opening ratio of the air recirculation valve 130 or the speed of the hydrogen recirculation pump 290 according to the required output of the fuel cell stack 600 and the magnitude of the output voltage or output current.

In detail, when the required output of the fuel cell stack 600 is high, the flow rate and pressure of air introduced into the fuel cell stack 600 through the air line 100 is maintained at a high level. Thus, the air can be evenly distributed to each cell of the fuel cell stack 600.

However, when the required output of the fuel cell stack 600 is low, the flow rate and pressure of air introduced into the fuel cell stack 600 through the air line 100 is maintained at a low level. Thus, the air cannot be evenly distributed to each cell of the fuel cell stack 600 due to its relatively low pressure and has a biased distribution.

Thus, voltage and current deviations between cells of the fuel cell stack 600 may occur and thus may cause deterioration of the fuel cell stack 600 and may adversely affect durability.

In order to solve this problem, recirculation of already used hydrogen and air is controlled so that even when the flow rates of newly introduced hydrogen and air are small, the hydrogen recirculation pump 290, the air recirculation valve 170, the air compressor 150, or the air control valve 150 allows hydrogen or air to be maintained an appropriate pressure inside the anode or the cathode. Thus, hydrogen or air may be distributed evenly over the anode or the cathode.

Meanwhile, the controller 500 may include a communication device communicating with another controller or a sensor to control a corresponding function to which the controller is in charge. The controller 500 may also include a memory storing an operating system (OS), logic commands, input/output information, and the like. The controller 500 may also include one or more processors performing determination, calculation, decision, and the like required for the control of the corresponding function.

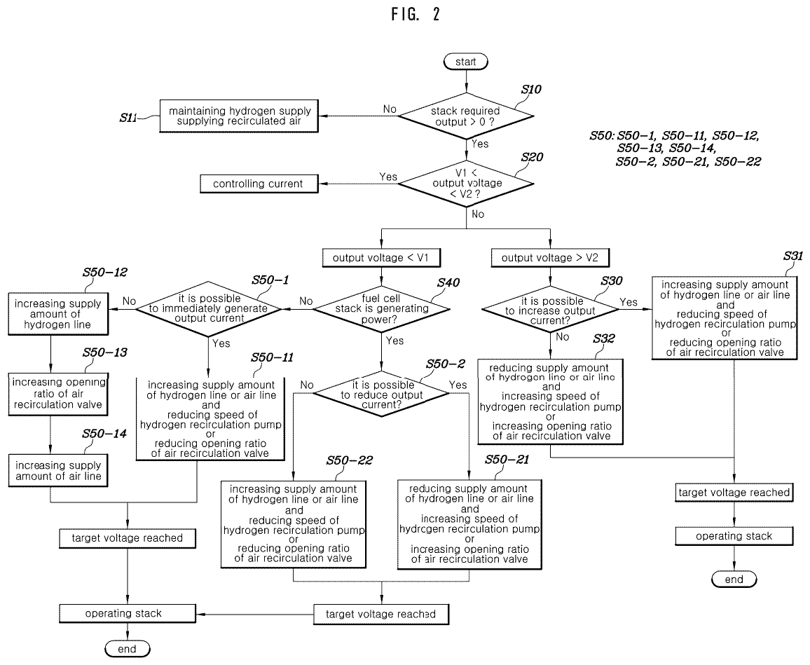

Referring to FIG. 2, the controller 500 determines whether a required output of the fuel cell stack 600 exists (S10). When the required output does not exit (No in S10), the controller 500 supplies recirculated air to the cathode through the air recirculation line 180 while maintaining supply of hydrogen through the hydrogen recirculation line 280 (S11).

In detail, when the required output of the fuel cell stack 600 does not exist, it means a situation in which a battery (not illustrated) provided in the fuel cell system needs to be discharged but the output of the fuel cell stack 600 is unnecessary. In this case, the output generated by the fuel cell stack 600 is used to drive accessories (driving assistance devices) of the fuel cell stack 600 and uses the output.

When the required output of the fuel cell stack 600 does not exist (No in S10), supply of hydrogen through the hydrogen line 200 or the hydrogen recirculation line 280 is maintained (S11). However, air is circulated through the cathode via the air recirculation line 180. Oxygen in the atmosphere reacts with hydrogen to generate output, but the generated output is consumed by accessories, etc. Of the recirculated air, oxygen is all consumed, and some remaining gas (such as nitrogen) is recirculated through the cathode so that the cathode is maintained at a constant pressure.

At this time, when the nitrogen fraction of the air introduced into the cathode is excessive, the air recirculation valve 170 is temporarily closed to release the used air into the atmosphere and introduce new air into the cathode so that the nitrogen fraction of the air introduced into the cathode is maintained at an atmospheric level.

Furthermore, when the required output of the fuel cell stack 600 exists (Yes in S10), the pressure of gas newly introduced through the air line 100 and the pressure of recirculated air are combined to form an appropriate pressure at the cathode. Thus, the pressure is evenly distributed over the cathode of each cell of the fuel cell stack 600, and thus deterioration of the fuel cell stack 600 is prevented.

Meanwhile, the controller 500 stores an upper limit value V2 and a lower limit value V1 of the output voltage of the fuel cell stack 600. When the required output of the fuel cell stack 600 exists, the controller 500 controls power generation of the fuel cell stack 600 so that the output voltage of the fuel cell stack 600 is maintained between the upper limit value V2 and the lower limit value V1.

In detail, referring to FIG. 2, in a state in which the required output of the fuel cell stack 600 exists, the current output voltage of the fuel cell stack 600 is checked (S20). The fuel cell stack 600 has an upper limit value and a lower limit value of the voltage at which deterioration is increased.

For this reason, in order to prevent deterioration of the fuel cell stack 600, the voltage may be maintained between the upper limit value V2 and the lower limit value V1. Thus, when the required output of the fuel cell stack 600 exists, the output voltage of the fuel cell stack 600 is checked in advance (S20). When the output voltage is not between the limit values, i.e., is above the upper limit value V2 or below the lower limit value V1 (No in S20), power generation of the fuel cell stack 600 may be controlled so that the output voltage is maintained between the upper limit value V2 and the lower limit value V.

When the output voltage of the fuel cell stack 600 exceeds the upper limit value V2, the controller 500 reduces the output voltage to be equal to or less than the upper limit value V2 1) by increasing a supply amount of the hydrogen line 200 or the air line 100 when it is possible to increase the output current, and 2) by increasing the speed of the hydrogen recirculation pump 290 or increasing the opening ratio of the air recirculation valve 170 when increasing the output current is limited.

In detail, referring to FIG. 2, in a state in which the required output of the fuel cell stack 600 exists, the current output voltage of the fuel cell stack 600 is checked (S20). When the output voltage of the fuel cell stack 600 exceeds the upper limit value V2, the output voltage of the fuel cell stack 600 needs to be reduced to be equal to or less than the upper limit value V2.

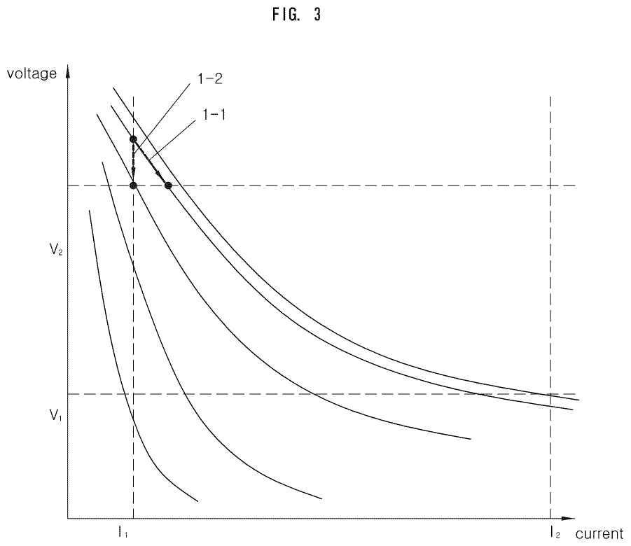

Thus, the controller 500 determines whether it is possible to increase the output current of the fuel cell stack 600 (S30). Referring to FIGS. 2 and 3, when it is possible to increase the output current of the fuel cell stack 600 (Yes in S30), the controller 500 increases the supply amount of the hydrogen line 200, the air line 100, or both and reduces the speed of hydrogen recirculation pump 290, the opening ratio of the air recirculation valve 170 or both. Thus, the output current is increased through reactions of hydrogen and air, and the voltage is thereby reduced (1−1) along an IV curve (S31).

On the other hand, when it is not possible to increase the output current of the fuel cell stack 600 (No in S30), the controller 500 reduces the supply amount of the hydrogen line 200, the air line 100, or both and increases the speed of the hydrogen recirculation pump 290, the opening ratio of the air recirculation valve 170, or both. Thus, the amounts of hydrogen and air reacted are reduced, and the voltage is thereby reduced (1−2) (S32).

Meanwhile, when the output voltage of the fuel cell stack 600 is less than the lower limit value V1, the controller 500 increases the output voltage to be equal to or higher than the lower limit value V1 depending on whether the fuel cell stack 600 is generating power (S40) and whether the output current is variable (S50-1, 50-2).

In detail, referring to FIG. 2, in a state in which the required output of the fuel cell stack 600 exists, a current output voltage of the fuel cell stack 600 is checked (S20). When the output voltage of the fuel cell stack 600 is less than the lower limit value V1, the output voltage of the fuel cell stack 600 needs to be increased to be equal to or higher than the lower limit value V1. When the output voltage of the fuel cell stack 600 is less than the lower limit value V1, a control method may be determined depending on whether the output current of the fuel cell stack 600 is variable (S50).

Meanwhile, when it is determined that the fuel cell stack 600 is not generating power, the controller 500 increases the supply amount of the hydrogen line 200 or the air line 100 so that the output voltage is increased to be equal to or higher than the lower limit value V1.

In detail, when the fuel cell stack 600 is not generating power (No in S40), it may mean a situation in which ignition of the fuel cell stack 600 is turned off. In this case, a control method may be determined by determining whether it is possible for the fuel cell stack 600 to immediately generate output current (S50-1).

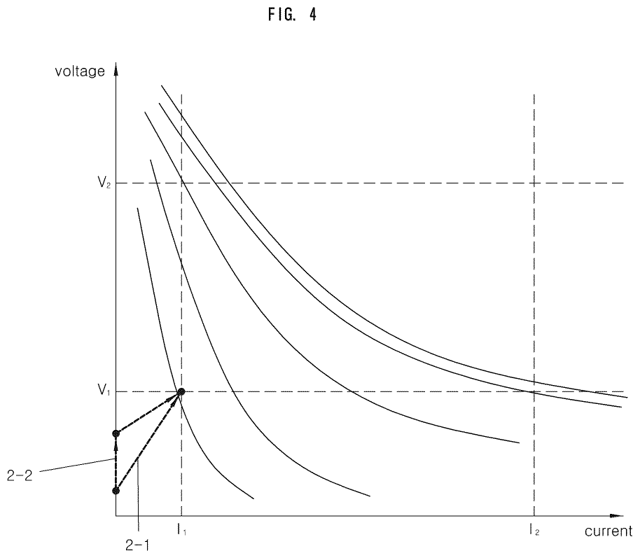

In detail, referring to FIGS. 2 and 4, when it is possible to immediately generate the output current of the fuel cell stack 600 (Yes in S50-1), the controller 500 increases the supply amount of the hydrogen line 200 or the air line 100 (S50-11) or both so that the voltage is increased (2−1).

When the controller 500 increases the supply amount of the hydrogen line 200, the air line 100, or both, the speed of the hydrogen recirculation pump may decrease, the opening amount of the air recirculation valve may decrease, or both.

On the other hand, when it is not possible to immediately generate the output current of the fuel cell stack 600 (No in S50-1), the controller 500 increases the supply amount of the hydrogen line 200 (S50-12), increases the opening ratio of the air recirculation valve 170 (S50-13), and then increases the supply amount of the air line 100 (S50-14) so that the output voltage is increased to be equal to higher than the lower limit value V1 (2−2).

Meanwhile, increasing the supply amount of the hydrogen line 200 or the air line 100 may prevent reverse current from occurring due to air introduced into the anode inside each cell of the fuel cell stack 600.

In this case, because it is not possible to immediately generate the output current, the amount of hydrogen supplied is increased first through the hydrogen line 200 (S50-12). After that, at the time point when generation of the output current becomes possible or hydrogen and air barely react inside the stack 600 (this time point can be determined on the basis of the concentration of hydrogen at the outlet side of the anode), the controller 500 increases the opening ratio of the air recirculation valve 170 (S50-13) to increase the pressure of recirculated air to the cathode and increases the flow rate of air through the air line 100 (S50-14). In this manner, the output voltage is increased (2−2) to be equal to or higher than the lower limit value V1.

Meanwhile, when it is determined that the fuel cell stack 600 is generating power (Yes in S40) and it is possible to reduce the output current of the fuel cell stack 600 (Yes in S50-2), the controller 500 increases the speed of the hydrogen recirculation pump 290 or increases the opening ratio of the air recirculation valve 170 and reduces the supply amount of the hydrogen line 200 or the air line 100 (S50-21). Thus, the output voltage is increased to be equal to or higher than the lower limit value V1 (3−2). On the other hand, when it is not possible to reduce the output current (No in S50-2), the controller 500 increases the supply amount of the hydrogen line 200, the air line 100 (S50-22) or both. Thus, the output voltage is increased to be equal to or higher than the lower limit value V1 (3−1).

When the controller 500 increases the supply amount of the hydrogen line 200, the air line 100, or both, the speed of the hydrogen recirculation pump may decrease, the opening amount of the air recirculation valve may decrease, or both.

In detail, when the fuel cell stack 600 is generating power, it may mean a situation in which ignition of the fuel cell stack 600 is turned on and the fuel cell stack 600 is currently operating with high output. In this case, a control method may be determined by determining whether it is possible for the fuel cell stack 600 to reduce the output current (S50-2).

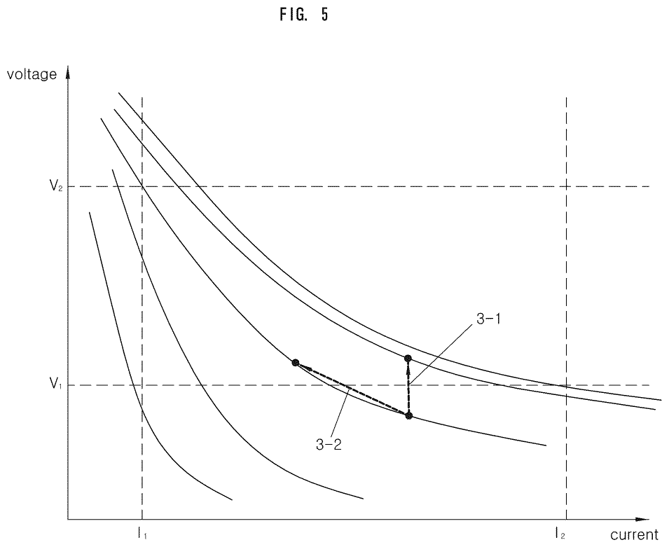

In detail, referring to FIGS. 2 and 5, when it is possible to reduce the output current of the fuel cell stack 600 (Yes in S50-2), the controller 500 increases the speed of the hydrogen recirculation pump 290 or increases the opening ratio of the air recirculation valve 170 (S50-21) and reduces the supply amount of the hydrogen line 200, the air line 100, or both. The output current is reduced by reducing the amounts of hydrogen and air reacted, and the output voltage is thereby increased to be equal to or higher than the lower limit value V1 along an IV curve (3−2).

On the other hand, when it is not possible to reduce the output current of the fuel cell stack 600 (No in S50-2), the controller 500 increases the supply amount of the hydrogen line 200 or the air line 100 and reduces the speed of the hydrogen recirculation pump 290 or reduces the opening ratio of the air recirculation valve 170. Thus, the output voltage is temporarily increased (3−2).

In this case, the hydrogen is supplied first to the anode through the hydrogen line 200. After that, at the time point when the hydrogen and the air hardly react inside the stack 600 (this time point can be determined on the basis of the concentration of hydrogen at the outlet side of the anode), the controller 500 increases the flow rate of air through the air line 100. In this manner, the output voltage is temporarily increased (3−2).

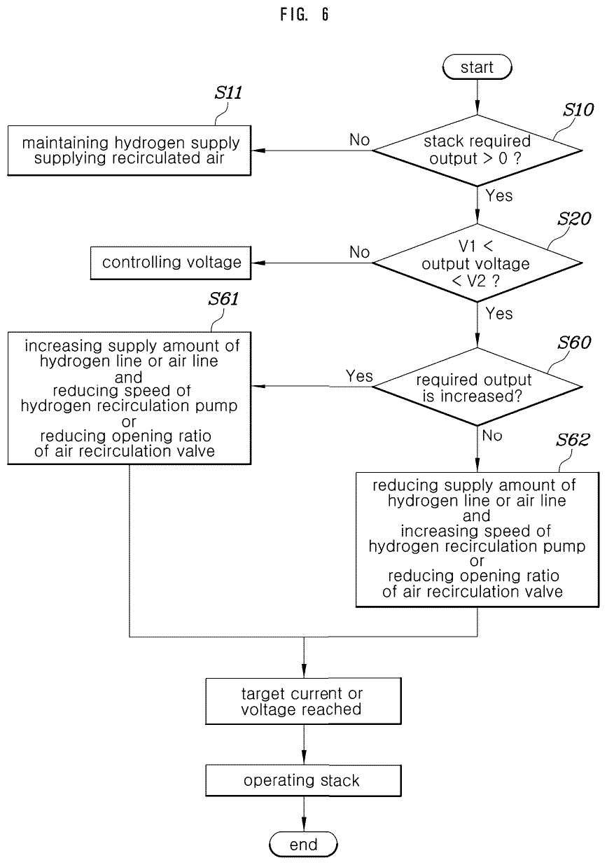

Meanwhile, the controller 500 determines whether the required output of the fuel cell stack 600 exists (S10), and when the required output of the fuel cell stack 600 exists, checks the current voltage of the fuel cell stack 600 (S20). When the current voltage is within a normal range (Yes in S20), the controller 500 controls power generation of the fuel cell stack 600 by varying the output current or output voltage of the fuel cell stack 600 depending on whether the required output of the fuel cell stack 600 is increased or reduced (S60) (see FIG. 6).

In detail, referring to FIG. 6, when the required output of the fuel cell stack 600 exists (Yes in S10) and the output voltage is within the normal range (No in S20), the controller 500 controls the amount of output of the fuel cell stack 600 by varying the output current or the output voltage depending on whether a previous required output is increased or reduced (S60).

When the required output of the fuel cell stack 600 is increased (Yes in S60), it may be, for example, a situation in In which high-output operation is required in an idle state. In this case, the flow rate of hydrogen or air through the hydrogen line 200 or the air line 100 is increased, and the speed of the hydrogen recirculation pump 290 is reduced or the opening ratio of the air recirculation valve 170 is reduced so that recirculation of already used hydrogen or air is reduced (S61). Thus, the amounts of hydrogen and air reacted are increased, making high-output operation possible.

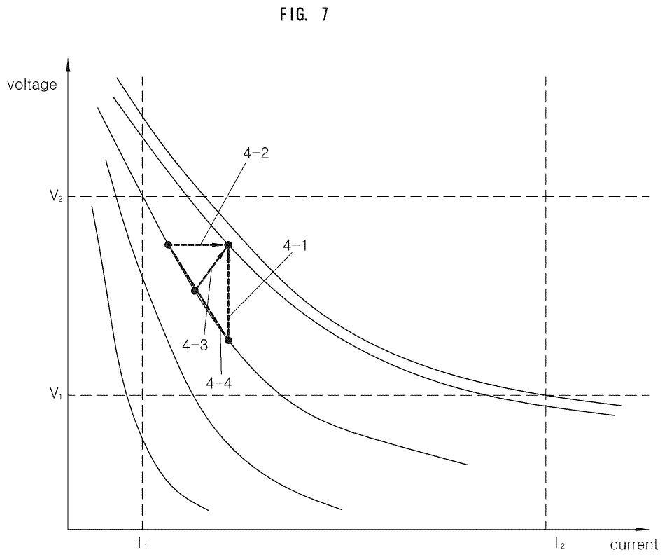

In detail, referring to FIG. 7, there may be cases where the output is increased by keeping the current constant and increasing the voltage (4−1), the output is increased by keeping the voltage constant and increasing the current (4−2), the output is increased by increasing both the voltage and current (4−3), and the output is increased along an IV curve (4−4). Here, which control method is to be selected may be determined according to a specific operating state of the fuel cell system.

In other words, it may be advantageous that the fuel cell system is operated between the upper limit value V2 and the lower limit value V1 of the voltage. However, in high-output operation of the fuel cell system, it may be more advantageous that the fuel cell system is operated in a different range between the upper and lower limit values V2 and V1 to achieve high efficiency. This range is variable according to the operating state.

The operating state may include, for example, an operating state in which control to maintain the voltage and increase the current is appropriate, an operating state in which control to maintain the current and increase the voltage is appropriate, and an operating state in which control to increase both the voltage and the current is appropriate. Depending on these circumstances, a control method may be determined.

Meanwhile, when the required output of the fuel cell stack 600 is reduced (No in S60), the controller 500 controls power generation of the fuel cell stack 600 by varying the output current or output voltage by reducing the supply amount of the hydrogen line 200 or the air line 100 and by increasing the speed of the hydrogen recirculation pump 290 or increasing the opening ratio of the air recirculation valve 170 (S62).

When the required output of the fuel cell stack 600 is reduced, it may be, for example, a situation in which a high-power operating state is changed to an idle state. In this case, the flow rate of hydrogen or air through the hydrogen line 200 or the air line 100 is reduced, and the speed of the hydrogen recirculation pump 290 is increased or the opening ratio of the air recirculation valve 170 is increased so that recirculation of already used hydrogen or air is increased (S62) to reduce the amounts of hydrogen and air reacted.

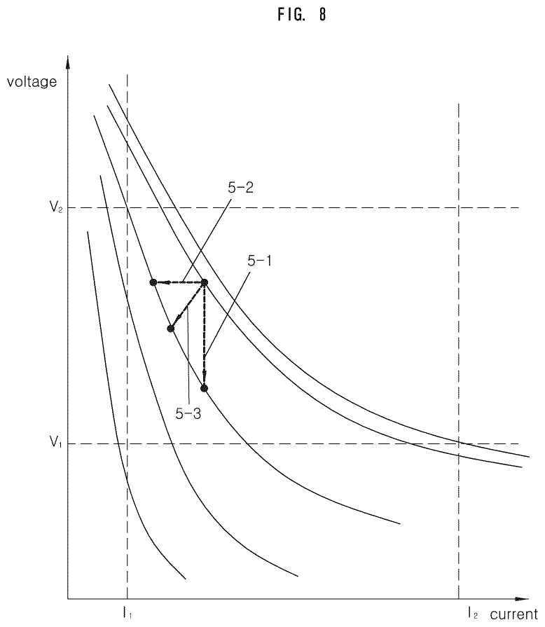

In detail, referring to FIG. 8, there may be cases where the output is reduced by keeping the current constant and reducing the voltage (5−1), the output is reduced by keeping the voltage constant and reducing the current (5−2), and the output is reduced by reducing both the voltage and the current (5−3). Here, which control method is to be selected may be determined according to a specific operating state of the fuel cell system.

Although specific embodiments of the present disclosure have been described for illustrative purposes, those having ordinary skill in the art should appreciate that various modifications, additions, and substitutions are possible, without departing from the scope and spirit of the present disclosure as disclosed in the appended claims.

What is claimed is:

1. A fuel cell system comprising:
an air line configured to supply air, pressurized by an air compressor, to a cathode of a fuel cell stack;
a hydrogen line configured to supply hydrogen to an anode of the fuel cell stack;
an air recirculation line branched from the air line and configured to connect an outlet side and an inlet side of the cathode;
an air control valve provided on the air line and configured to control a flow rate of air supplied to the cathode;
an air recirculation valve provided at an outlet side of the air line and configured to control a flow rate of air flowing into the air recirculation line;
a hydrogen recirculation line branched from the hydrogen line and configured to connect an outlet side and an inlet side of the anode;
a hydrogen recirculation pump provided on the hydrogen recirculation line and configured to pressurize recirculated hydrogen; and
a controller configured to adjust a flow rate of recirculated air or hydrogen according to a required output of the fuel cell stack and a magnitude of an output voltage or output current.

2. The fuel cell system of claim 1, wherein the controller adjusts the flow rate of recirculated air or hydrogen by adjusting a speed of the air compressor, by adjusting an opening ratio of the air control valve, by adjusting an opening ratio the air recirculation valve, or by adjusting a speed of the hydrogen recirculation pump.

3. The fuel cell system of claim 2, wherein the controller increases the flow rate of recirculated air by increasing the opening ratio of the air recirculation valve or decreases the flow rate of recirculated air by reducing the opening ratio of the air recirculation valve, and wherein the controller adjusts a pressure of recirculated air by adjusting the speed of the air compressor or the opening ratio of the air control valve.

4. The fuel cell system of claim 1, wherein, when the required output of the fuel cell stack does not exit, the controller maintains supply of hydrogen through the hydrogen line or the hydrogen recirculation line and supplies recirculated air to the cathode through the air recirculation line.

5. The fuel cell system of claim 4, wherein the controller stores an upper limit value and a lower limit value of the output voltage of the fuel cell stack, and wherein when the required output of the fuel cell stack exists, the controller controls power generation of the fuel cell stack so that the output voltage of the fuel cell stack is maintained between the upper limit value and the lower limit value.

6. The fuel cell system of claim 5, wherein, when the output voltage of the fuel cell stack exceeds the upper limit value, the controller reduces the output voltage to be equal to or less than the upper limit value 1) by increasing a supply amount of the hydrogen line or the air line when it is possible to increase the output current, and 2) by increasing a speed of the hydrogen recirculation pump or increasing an opening ratio of the air recirculation valve when increasing the output current is limited.

7. The fuel cell system of claim 5, wherein, when the output voltage of the fuel cell stack is less than the lower limit value, the controller increases the output voltage to be equal to or higher than the lower limit value depending on whether the fuel cell stack is generating power and whether the output current is variable.

8. The fuel cell system of claim 7, wherein, when it is determined that the fuel cell stack is not generating power, the controller increases a supply amount of the hydrogen line or the air line so that the output voltage is increased to be equal to or higher than the lower limit value.

9. The fuel cell system of claim 8, wherein:
when it is possible to immediately generate the output current of the fuel cell stack, the controller controls a voltage by increasing the supply amount of the hydrogen line or the air line; and
when it is not possible to immediately generate the output current, the controller increases the supply amount of the hydrogen line, increases an opening ratio of the air recirculation valve, and then increases the supply amount of the air line so that the output voltage is increased to be equal to higher than the lower limit value.

10. The fuel cell system of claim 7, wherein:
when it is determined that the fuel cell stack is generating power and it is possible to reduce the output current of the fuel cell stack, the controller increases a speed of the hydrogen recirculation pump or increases an opening ratio of the air recirculation valve and reduces a supply amount of the hydrogen line or the air line so that the output voltage is increased to be equal to or higher than the lower limit value; and
when it is not possible to reduce the output current, the controller increases the supply amount of the hydrogen line or the air line so that the output voltage is increased to be equal to or higher than the lower limit value.

11. The fuel cell system of claim 1, wherein:
when the required output of the fuel cell stack exists, the controller checks a current voltage of the fuel cell stack; and
when the current voltage is within a normal range, the controller controls power generation of the fuel cell stack by varying the output current or output voltage of the fuel cell stack depending on whether the required output of the fuel cell stack is increased or reduced.

12. The fuel cell system of claim 11, wherein, when the required output of the fuel cell stack is increased, the controller controls a current or voltage by increasing a supply amount of the hydrogen line or the air line and reducing a speed of the hydrogen recirculation pump or reducing an opening ratio of the air recirculation valve.

13. The fuel cell system of claim 11, wherein, when the required output of the fuel cell stack is reduced, the controller controls power generation of the fuel cell stack by varying the output current or output voltage by reducing a supply amount of the hydrogen line or the air line and increasing a speed of the hydrogen recirculation pump or increasing an opening ratio of the air recirculation valve.

14. A method of controlling the fuel cell system of claim 1, the method comprising:
determining, by the controller, the magnitude of the output voltage or output current according to the required output of the fuel cell stack; and
controlling, by the controller, the flow rate of recirculated air or hydrogen according to the determined magnitude of the output voltage or output current.

15. The method of claim 14, wherein the controller adjusts the flow rate of recirculated air or hydrogen by adjusting a speed of the air compressor, by adjusting an opening ratio of the air control valve, by adjusting an opening ratio of the air recirculation valve, or by adjusting a speed of the hydrogen recirculation pump.
